(19) United States
(12) Patent Application Publication
(10) Pub. No.: US 2005/0228093 A1
(43) Pub. Date: Oct. 13, 2005

(54) Thermoconductive composition

(76) Inventors: Yoshinao Yamazaki, Kanagawa (JP); Mitsuhiko Okada, Tokyo (JP); Tomoya Tanzawa, Kanagawa (JP)

Correspondence Address: 3M INNOVATIVE PROPERTIES COMPANY, PO BOX 33427, ST. PAUL, MN, 55133-3427, US

(21) Appl. No.: 10/486,779

(22) PCT Filed: Jul. 29, 2002
(86) PCT No.: PCT/US02/23960

§ 371 Date: Feb. 12, 2004

(30) Foreign Application Priority Data
Sep. 21, 2002 (JP) 2001-289591

(51) Int. Cl. C08K 3/38

(52) U.S. Cl. 524/404

(57) ABSTRACT

In a thermoconductive composition containing wax, a substantially spherical boron nitride is added as a filler. The average particle size of the substantially spherical boron nitride is preferably from 20 to 100 μm and the filling ratio is preferably from 10 to 30% by volume.

### DETAILED DESCRIPTION OF THE INVENTION

1. Technical Field

The present invention relates to a thermoconductive composition, more specifically, the present invention relates to a thermoconductive composition useful for closely contacting to exothermic electronic components such as CPU and releasing the heat to the outside.

2. Background Art

In recent years, the removal of heat from heating elements has become an important issue in various fields. Particularly, the removal of heat from exothermic electronic components (e.g., IC chip) and other components (hereinafter collectively called “exothermic components”) self-contained, for example, in various devices such as electronic device and personal computer has become an important issue. This is because, as the temperature of various exothermic components rises, the probability of that component malfunctioning tends to increase exponentially. More recently, the requirements placed on exothermic components are becoming severer so as to keep up with more reduction in the size of exothermic components and higher processing speed.

At present, in order to dissipate heat generated and accumulated in an exothermic component from the component, a heat radiator such as heat sink, radiation fin or metal heat slinger is fixed to the exothermic component. Also, various thermoconductive materials or sheets are used as a heat transfer spacer between an exothermic component and a heat radiator so as to allow the material or sheet to act as a heat transfer medium.

For example, a grease containing a thermoconductive filler has been generally used as a thermoconductive material because of its extremely low thermal resistance. The grease itself exerts excellent thermal conductivity, however, the grease is liquid and therefore, a long time and much labor are required in disposing it between an exothermic component and a heat radiator. Thus, the grease has a problem of poor handleability and in addition, suffers from problems such as contamination to the surroundings or difficulty of coating in a constant amount.

In order to overcome this problem, a thermoconductive sheet obtained by forming a thermoconductive material into the form of a sheet has been proposed. The heat conductivity of conventional thermoconductive sheets is elevated by highly filling a filler having a high thermal conductivity. For example, European Patent Publication 0322165 and Japanese Unexamined Patent Publication No. 11-26661 describe a thermoconductive sheet where boron nitride having a large particle size is used as a filler and filled at a high filling rate of 30 to 60% by volume. However, since the filler is highly filled and the binder is a thermosetting resin or elastomer, this sheet suffers from a large compression resiliency at the time of integrating it into equipment. Furthermore, this sheet cannot have an initial thickness smaller than the range of 300 to 500 μm in view of the limitation of mechanical strength and also, the thickness of the sheet integrated in equipment cannot be made smaller than 200 to 300 μm due to the large compression resiliency. Accordingly, the thermal resistance of this sheet is extremely large as compared with the grease of which thickness after it is integrated can be reduced to tens of μm.

On the other hand, a phase change-type thermoconductive sheet using wax as a binder is a thermoconductive sheet having high heat radiation performance and excellent handleability, because since the wax melts on heating and undertakes phase-change, the sheet thickness is reduced and the final thermal resistance becomes as low as comparable to that of grease. For example, Japanese Unexamined International Patent Publication No. 2000-509209 describes a thermoconductive sheet comprising wax and plate-like boron nitride having an average particle size of 7 to 10 μm. In this thermoconductive sheet, since the filler has a plate-like form and the binder has fluidity, the sheet thickness after the phase-change is reduced to from 50 to 100 μm and the final thermal resistance becomes as low as comparable to that of grease. However, the plate-like boron nitride has an anisotropy such that the thermal conductivity in the plane direction is about 20 times higher than the thermal conductivity in the thickness direction, and when this plate-like boron nitride is formed into a sheet, the plate-like crystals are oriented in the plane direction of the sheet, therefore, the thermal conductivity in the thickness direction of the sheet is low and the initial thermal resistance before the phase-change is extremely high. As a result, an exothermic component having integrated thereinto this sheet is excessively overheated at the first charging of power source for inspecting the rising of equipment and a shutdown program is run, giving rise to a time loss of waiting for the component to cool.

### PROBLEMS TO BE SOLVED BY THE INVENTION

The object of the present invention is to overcome these problems and provide a thermoconductive composition capable of reducing, particularly, the initial thermal resistance at the rising of equipment.

### MEANS TO SOLVE THE PROBLEMS

According to the present invention, the above-described objects can be attained by a thermoconductive composition comprising wax and substantially spherical boron nitride. By incorporating substantially spherical boron nitride as a thermoconductive filler, the thermoconductive sheet can have by far higher thermal conductivity in the thickness direction than that in the case of using plate-like boron nitride particles and can be reduced in the initial thermal resistance before the phase-change.

### MODE FOR CARRYING OUT THE INVENTION

The thermoconductive composition of the present invention contains wax and substantially spherical boron nitride as essential components. The wax is not particularly limited and natural wax, synthetic wax or blended wax can be used. Examples of the natural wax include plant waxes such as candelilla wax, carnauba wax, rice wax, haze wax and jojoba oil; animal waxes such as beeswax, lanolin and spermaceti; mineral waxes such as montan wax, ozokerite and ceresin; and petroleum waxes such as paraffin wax, microcrystalline wax and petrolactam. Examples of the synthetic wax include synthetic hydrocarbons such as Fischer-Tropsch wax and polyethylene wax; denatured waxes such as montan wax derivatives, paraffin wax derivatives and microcrystalline wax derivatives; hydrogenated waxes such as hydrogenated castor oil and hydrogenated castor oil derivatives; fatty acids, acid amides, esters, ketones, and other waxes such as 12-hydroxystearic acid, stearic acid amide, anhydrous phthalic imide and chlorinated hydrocarbon. The melting point of this wax is preferably from 30 to 150° C., more preferably from 40 to 80° C.

The substantially spherical boron nitride is obtained, for example, by granulating primary crystals of boron nitride using atomization or the like and then sintering the obtained particles or by manufacturing a sinter-molded block and pulverizing the block. This boron nitride is substantially spherical, as used herein, includes those particles with an aspect ratio of 1 to 5 and further includes those particles that are elliptical. In the case where the boron nitride is in the plate form and a sheet formed of a thermoconductive composition containing this boron nitride is disposed between an exothermic component and a heat radiator as described above, a sufficiently high thermal conductivity cannot be attained in the thickness direction of the sheet because the boron nitride orientates in the sheet plane direction. On the other hand, when the boron nitride is rendered spherical, the thermal conductivity in the sheet thickness direction can be increased, particularly, the initial thermal resistance before the phase-change can be reduced.

The average particle size of this substantially spherical boron nitride is preferably from 20 to 100 μm, more preferably from 30 to 60 μm. If the boron nitride particles used have an average particle size of less than 20 μm, the thermal conductivity in the thickness direction lowers, whereas if the average particle size of the particles exceeds 100 μm, the thermoconductive sheet after the phase-change can be hardly reduced in the thickness and sometimes has a high final thermal resistance. The filling ratio of the substantially spherical boron nitride is preferably from 10 to 30% by volume based on the entire thermoconductive composition. If the filling ratio is less than 10% by volume, a sufficiently high thermal conductivity can be hardly obtained, whereas if it exceeds 30% by volume, the thermoconductive sheet after the phase-change can be hardly reduced in the thickness and sometimes has a high final thermal resistance.

The thermoconductive composition of the present invention may contain, in addition to the above-described wax and substantially spherical boron nitride, a compound represented by the following formula (I): 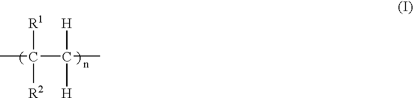
(wherein R¹ and R² each independently represents an alkyl group having from 1 to 3 carbon atoms and n represents a value of 100 to 100,000). In the compound represented by formula (I), R¹ and R² both are preferably a methyl group. That is, the compound represented by formula (I) is preferably polyisobutylene. The number n of repeating units is from 100 to 100,000 and the molecular weight is preferably from 1,000 to 1,000,000, more preferably from 30,000 to 60,000. The amount blended of the compound represented by formula (I) is from 10 to 1,000 parts, preferably from 20 to 100 parts, per 100 parts by weight of wax.

The compound of formula (I) is a liquid polymer having a pour point (prescribed by JIS K 2269) of room temperature or more. The thermoconductive composition containing the compound represented by formula (I) is free of elastic components, exhibits excellent fluidity at the melting, exerts extremely excellent heat radiation characteristics, causes no excessive tacking, provides a sheet improved in the embrittlement and having strong strength and at the same time, ensures remarkably good handleability.

The thermoconductive composition of the present invention may contain a softening agent in addition to the compound represented by formula (I). By adding a softening agent, the fluidity of the thermoconductive composition can be improved, the close contacting between an exothermic component and a heat radiator can be improved and the thermal conductivity can be further elevated. Examples of the softening agent which can be used include a plant-type softening agent, a mineral-type softening agent and a synthetic plasticizer, each being compatible with wax. Examples of the plant-type softening agent which can be used include cottonseed oil, linseed oil and rapeseed oil. Examples of the mineral-type softening agent which can be used include paraffin-type oil, naphthene-type oil and aromatic oil. Examples of the synthetic plasticizer which can be used include dioctyl phthalate, dibutyl phthalate, dioctyl adipate, isodecyl adipate, dioctyl sebacate and dibutyl sebacate. Among these, naphthene-type oil and paraffin-type oil are preferred. The amount of the softening agent blended is 1,000 parts or less, preferably 10 parts or less, per 100 parts by weight of wax.

In addition to the above-described components, various additives commonly used in the polymer chemistry can be added to the thermoconductive composition of the present invention. For example, a tackifier, a plasticizer and the like may be added so as to adjust the tackiness of the sheet formed, and a flame retardant and an antioxidant may be added so as to elevate the thermal resistance. Other examples of the additive include a modifier, a heat stabilizer and a coloring agent. Also, the above-described substantially spherical boron nitride may be previously treated with a surface-treating agent such as silane coupling agent.

The thermoconductive composition of the present invention can be produced by mixing these components each in a predetermined amount. The thermoconductive composition can be formed into a sheet or a film by the method commonly known in this field. For example, wax, substantially spherical boron nitride, a desired compound represented by formula (I), a softening agent and the like are kneaded in a heat mixer and the kneaded material is coated like a liner by the hot-melt coating and thereby formed into a sheet. Or, the above-described components are diluted with an appropriate solvent and mixed in a mixer and the mixture is coated on a liner by the solvent casting method and thereby formed into a sheet.

The sheet can be formed to various thicknesses according to the use end or portion to which the sheet is applied, however, in general, the thickness, which is preferably as small as possible, is preferably from 0.02 to 2.0 mm, more preferably from 0.1 to 0.5 mm. If the thickness is less than 0.02 mm, a sufficiently high adhesive strength may not be attained between an exothermic component and a heat radiator and the obtained heat radiation property cannot be satisfied, whereas if the thickness exceeds 2.0 mm, the extrusion from the fixing areas of the thermoconductive component and the heat radiator increases and gives rise to unnecessary adhesion to the periphery.

The thus-formed sheet may be used directly as the heat transfer means. However, if desired, the sheet may be used by combining with an appropriate substrate. Examples of the appropriate substrate include plastic film, woven fabric, nonwoven fabric and metal foil. Examples of the woven fabric and the nonwoven fabric include woven and nonwoven fabrics composed of fibers of glass, polyester, polyolefin, nylon, carbon, ceramic or the like, or such fibers applied with a metal coat. The substrate may be located as the surface layer or an intermediate layer of the sheet.

This sheet is solid at room temperature, so that the sheet can be used by interposing it between an exothermic component and a heat radiator, and can have excellent handleability as compared with the case of using a liquid grease. When an exothermic component is actuated, the interposed sheet is softened by the heat of the exothermic component to cause the phase-change and fills in the gap between the exothermic component and the heat radiator. Furthermore, since the space between the exothermic component and the heat radiator is fairly reduced in the thickness, the thermal resistance value can be greatly lowered. Accordingly, the softening point of the thermoconductive composition constituting this sheet is preferably from 30 to 150° C., more preferably from 40 to 100° C. This softening point can be freely selected according to the kind and amount of the constituent components.

In addition, this sheet as containing the compound represented by formula (I) in a predetermined amount exhibits excellent sheet strength such as tensile strength and bending strength, in comparison with conventional sheets using wax and can be used without causing any trouble such as tearing or cracking during the use.

### EXAMPLES

### Example 1

85% by volume of a binder comprising 75 parts by weight of paraffin wax having a melting point of 54° C. and 25 parts by weight of polyisobutylene having a molecular weight of 40,000, and 15% by volume of substantially spherical boron nitride aggregates (produced by Mizushima Gokin Tetsu Sha) having an average particle size of 50 μm as a filler were uniformly kneaded at 80° C. and the kneaded material was interposed between upper and lower liners and calendered at 80° C. to obtain a thermoconductive sheet having a thickness of 0.25 mm.

### Example 2

A thermoconductive sheet was produced in the same manner as in Example 1 except for using substantially spherical boron nitride aggregates (PT620, produced by Advanced Ceramics) having an average particle size of 20 μm as a filler.

### Example 3

A thermoconductive sheet was produced in the same manner as in Example 1 except for using substantially spherical boron nitride aggregates (obtained by classifying PT670 produced by Advanced Ceramics) having an average particle size of 100 μm as a filler.

### Example 4

A thermoconductive sheet was produced in the same manner as in Example 1 except for changing the filling ratio of filler to 25% by volume.

### Comparative Example 1

A thermoconductive sheet was produced in the same manner as in Example 1 except for using substantially spherical boron nitride aggregates (PT670, produced by Advanced Ceramics) having an average particle size of 200 to 300 μm as a filler. The thickness of the obtained sheet was 0.35 mm.

### Comparative Example 2

A thermoconductive sheet was produced in the same manner as in Example 1 except for using plate-like boron nitride (HP-1, produced by Mizushima Gokin Tetsu Sha) having an average particle size of 10 μm as a filler.

### Comparative Example 3

A thermoconductive sheet was produced in the same manner as in Example 1 except for using plate-like boron nitride (PT100, produced by Advanced Ceramics) having an average particle size of 45 μm as a filler.

### Comparative Example 4

A thermoconductive sheet was produced in the same manner as in Example 1 except for using substantially spherical alumina (CBA40, produced by Showa Denko K.K.) having an average particle size of 40 μm as a filler.

### Comparative Example 5

A thermoconductive sheet was produced in the same manner as in Example 1 except for changing the filling ratio of filler to 5% by volume.

### Comparative Example 6

A thermoconductive sheet was produced in the same manner as in Example 1 except for changing the filling ratio of filler to 35% by volume.

### Comparative Example 7

A thermoconductive sheet was produced in the same manner as in Comparative Example 2 except for changing the filling ratio of filler to 25% by volume.

Evaluation of Properties of Thermoconductive Sheet

The thermoconductive sheets produced above each was cut into a size of 10 mm×11 mm, peeled off from the liners and then interposed between an exothermic resistor and a cooling aluminum plate, and an electric power of 20 W was applied to the exothermic resistor. After the passing of 30 seconds and 30 minutes from the application of electric power, the temperature (T1) of exothermic resistor and the temperature (T2) of aluminum plate were measured and the thermal resistance value was calculated according to the formula below. The thermal resistance after 30 seconds was designated as the initial thermal resistance and the thermal resistance after 30 minutes was designated as the final thermal resistance.

Thermal resistance (° C. cm²/W)=(T1−T2)(° C.)×Sample Area(cm²)/Electric Power (W)

The results obtained are shown in Table 1 below. For the purpose of Reference Example, the thermal resistance was similarly measured using a thermoconductive grease (SE4490CV, produced by Dow Corning Toray Silicone Co.) having a thermal conductivity of 1.6 W/mK in place of the thermoconductive sheet.

| | Initial Thermal | Final Thermal |
|---|---|---|
| | Resistance | Resistance |
| | (° C. cm²/W) | (° C. cm²/W) |
| Example 1 | 2.2 | 1.3 |
| Example 2 | 2.4 | 1.3 |
| Example 3 | 2.2 | 1.7 |
| Example 4 | 2.0 | 1.5 |
| Comparative Example 1 | 2.6 | 3.0 |
| Comparative Example 2 | 3.2 | 1.7 |
| Comparative Example 3 | 3.1 | 1.4 |
| Comparative Example 4 | 3.5 | 3.2 |
| Comparative Example 5 | 4.5 | 2.9 |
| Comparative Example 6 | 2.1 | 2.9 |
| Comparative Example 7 | 2.8 | 2.2 |
| Reference Example | 1.1 | 1.3 |

As is apparent from the results above, the thermoconductive sheet formed using the composition of the present invention can lower both the initial thermal resistance and the final thermal resistance, in particular, can greatly lower the initial thermal resistance as compared with the case of using a plate-like filler.

### Effects of the Invention

By using substantially spherical boron nitride as a filler of a thermoconductive composition, the thermal conductivity of a thermoconductive sheet formed from this composition can be elevated, in particular, the initial thermal resistance before the phase-change can be greatly lowered.

1-9. (canceled)

10. A thermoconductive composition comprising wax and spherical boron nitride, optionally wherein said spherical boron nitride has an average particle size of 20 to 100 μm.

11. The thermoconductive composition as claimed in claim 10, wherein said spherical boron nitride is contained in an amount of 10 to 30% by volume based on the entire composition.

12. The thermoconductive composition of claim 10, which further comprises from 10 to 1,000 parts by weight of a compound represented by the following formula (I): 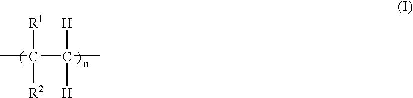
wherein R¹ and R² each independently represent an alkyl group having from 1 to 3 carbon atoms and n represents a value of 100 to 100,000, per 100 parts by weight of wax.

13. The thermoconductive composition as claimed in claim 12, wherein said compound represented by formula (I) is polyisobutylene.

14. The thermoconductive composition of claim 10, which is formed into a film or a sheet.

15. The thermoconductive composition as claimed in claim 14, wherein said film or sheet has a thickness of 0.02 to 2.0 mm.

16. The thermoconductive composition as claimed in claim 10, wherein said wax is selected from natural wax, synthetic wax, and blends thereof.

17. The thermoconductive composition as claimed in claim 10, wherein said wax is paraffin wax.
